(19) United States
(12) Patent Application Publication
(10) Pub. No.: US 2016/0211664 A1
(43) Pub. Date: Jul. 21, 2016

(54) Dispatch Controller for an Energy System

(71) Applicant: ROBERT BOSCH GMBH, Stuttgart (DE)

(72) Inventors: Maksim V. SUBBOTIN, San Carlos, CA (US); Binayak ROY, Sunnyvale, CA (US); Ashish S. KRUPADANAM, Cupertino, CA (US); Jasim AHMED, Mountain View, CA (US)

(21) Appl. No.: 14/914,527

(22) PCT Filed: Aug. 26, 2014
(86) PCT No.: PCT/US2014/052661

§ 371 Date: Feb. 25, 2016

Related U.S. Application Data
(60) Provisional application No. 61/869,862, filed on Aug. 26, 2013.

(51) Int. Cl. H02J 3/00; G05B 13/02

(52) U.S. Cl. CPC H02J 3/00; G05B 13/026

(57) ABSTRACT

A method and apparatus is provided to optimize the performance of energy resources interconnected in an energy system to provide an economic benefit to a customer. A dispatch controller and method of operation therefor provides for delivery of power from a number of energy resources to ensure acceptable operation of all components of the energy system while compensating for short-term fluctuations of loads or power generation from renewable resources. Optimized energy systems include an electric load, dispatchable sources of energy such as an electrical grid, diesel generators, combined heat and power generators; renewable sources of energy such as photovoltaic cells and wind turbines; and storage resources such as electrochemical batteries or pumped hydro reserves. The energy controller operates in one or more different modes, each of which is configured to operate an energy system according to different operating conditions.

### TECHNICAL FIELD

This disclosure relates generally to the field of energy systems and, more particularly, to systems and methods for delivering power from and storing energy in an energy system.

### BACKGROUND

Existing energy systems include a grid, a load, a power line system connecting the grid to the load, a controls/computer system, and a human machine interface to provide user access to the energy system through the controls/computer system. Energy assets including energy storage devices, dispatchable energy resources, and renewable energy resources, can also be included and are coupled to the grid to satisfy the energy requirements of one or more customers.

Energy systems include one or more electric loads, dispatchable sources of energy such as an electrical grid, diesel generators, combined heat and power generators, power plants such as nuclear, coal, and natural gas, renewable sources of energy such as photo-voltaic cells and wind turbines, and storage resources such as electrochemical batteries or pumped hydro reserves.

Utilization of energy storage devices such as electrochemical batteries in energy systems that supply electrical energy to residential, commercial or other loads can present certain opportunities in energy-savings, reducing requirements for distribution infrastructure, and integrating renewable resources into the electrical grid. Unlike conventional devices which require a balance of the amount of energy generated and consumed in a grid at any instant of time, storage devices allow the shifting of electrical energy consumption and power generation in time, from one period of time to another period of time. As a consequence, the energy generated by renewable resources in excess to a given load at a certain time or as provided by the electrical grid at low costs during periods of low loads, can be stored and provided on demand when this energy is required or is more expensive.

At the same time, however, utilization of energy storage devices presents new technical challenges related to the planning of optimal operation of these devices to provide a reliable supply of electrical energy and to maximize benefit to the owner of an energy storage system. Consequently, what is needed is an improved energy system including energy storage systems or devices whose operation can be optimized to store energy in and deliver power from the energy storage system as dictated by the demands of one or more power consuming customers.

### SUMMARY

Systems and methods for effecting the delivery of power from and the storage of energy in an energy system include a dispatch controller representing an integral component of an energy control system to maximize the benefits of an energy system. By integrating three components that individually solve prediction, planning, and execution tasks, the dispatch controller, which is in charge of the execution tasks, provides for a stable and cost efficient operation of an energy system. While a higher level energy system controller performs long term planning and optimization of the resources in an energy system, the dispatch controller ensures safe operation of the components in the energy system while compensating for any short-term fluctuations of loads or power generation from renewable resources.

In accordance with one embodiment of the present disclosure, there is provided a dispatch controller dedicated to control the operation of an energy system, wherein the dispatch controller includes at least one mode of operation.

In accordance with another embodiment of the present disclosure, there is provided a dispatch controller providing multiple modes of operation, each of which is selected by a multi-mode controller.

### BRIEF DESCRIPTION OF THE DRAWINGS

FIG. 1 is schematic block diagram of an energy system.

FIG. 2 is a detailed schematic block diagram of the energy system of FIG. 1.

FIG. 3 is a schematic block diagram of an energy system controller of the energy system of FIG. 2.

FIG. 4 is a schematic block diagram of a multi-mode dispatch controller in an operating environment.

### DESCRIPTION

For the purposes of promoting an understanding of the principles of the embodiments disclosed herein, reference is now made to the drawings and descriptions in the following written specification. No limitation to the scope of the subject matter is intended by the references. The present disclosure also includes any alterations and modifications to the illustrated embodiments and includes further applications of the principles of the disclosed embodiments as would normally occur to one skilled in the art to which this disclosure pertains.

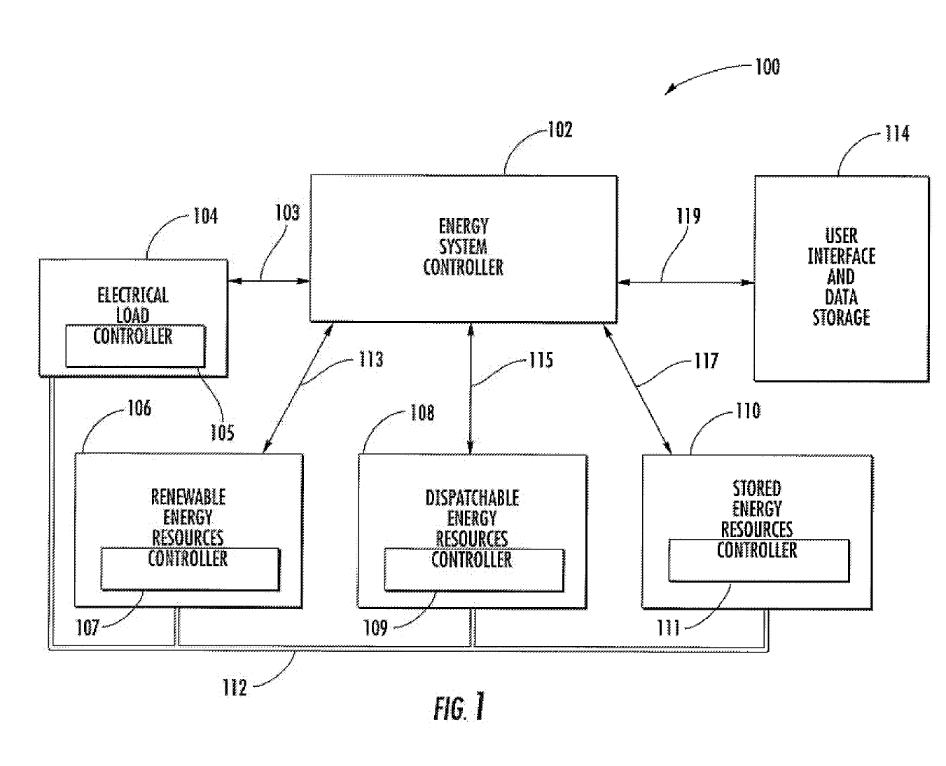

FIG. 1 illustrates an energy system 100 that includes one or more interconnected energy resources which have been optimized according to the present disclosure. The energy system 100 includes an energy system controller 102 operatively coupled to an electrical load 104, through a communications line 103. In different embodiments, the electrical load includes one or more electrical loads. The energy system controller 102 is also operatively coupled to one or more energy resources, including renewable energy resources 106 through a communications line 113, dispatchable energy resources 108 through a communications line 115, and stored energy resources 110 through a communications line 117. The electrical load 104, the renewable energy resources 106, the dispatchable energy resources 108, and the stored energy resources 110 are each operatively coupled to a power line 112 which provides for the transmission of energy from one or more of the energy resources to another energy resource and/or to the electrical load 104. A user interface, or human machine interface (HMI), and a data storage device 114 are also operatively coupled to the energy system controller 102 through a communications line 119. The communications lines 103, 113, 115, 117, and 119 are either hardwired or wireless or a combination thereof.

The energy system controller 102 provides for the control of energy generation and the selective transmission or delivery of power from an energy generation device or an energy storage device to a load or to an energy storage device. The controller 102 is operatively coupled to a controller 105 of the electrical load 104, a controller 107 of the renewable energy resources 106, a controller 109 of the dispatchable energy resources 108, and a controller 111 of the stored energy resources 110. Each of the controllers, 105, 107, 109, and 111 in different embodiments, includes processors and memories and receives and provides information in the form of signals to and from the controller 102. In addition, the controllers 105, 107, 109, and 111, in different embodiments, include control hardware, including switching devices to provide for the generation and transmission of energy or the storage of energy within the energy system 100. The energy system controller 102 obtains status information from each of the resources 106, 108, and 110 and also provides control signals to the controllers 105, 107, 109, and 111 for the generation and transmission or storage of energy in the system 100. The controller 102 is also operatively coupled to the controller 105 to receive status information of the load 104 indicative of the energy required by the load.

The controller 102 in different embodiments includes a computer, computer system, or programmable device, e.g., multi-user or single-user computers, desktop computers, portable computers and other computing devices. The controller 102 includes one or more individual controllers as described below and includes in different embodiments at least one processor coupled to a memory. The controller 102 includes, in different embodiments, one or more processors (e.g. microprocessors), and the memory in different embodiments includes random access memory (RAM) devices comprising the main memory storage of the controller 102, as well as any supplemental levels of memory, e.g., cache memories, non-volatile or backup memories (e.g. programmable or flash memories), read-only memories, etc. In addition, the memory in one embodiment includes a memory storage physically located elsewhere from the processing devices and includes any cache memory in a processing device, as well as any storage capacity used as a virtual memory, e.g., as stored on a mass storage device or another computer coupled to controller 102 via a network. The mass storage device in one embodiment includes a cache or other dataspace including databases.

The stored energy resources 110, in different embodiments, includes energy storage devices, such as electrochemical batteries such as those found in energy systems that supply electrical energy to residential loads, commercial loads or other types of loads and pumped hydro reserves. Utilization of the energy storage devices provides benefits in energy-savings by reducing the requirements for a distribution infrastructure and for integrating renewable energy resources into the electrical grid. Unlike conventional dispatchable resources which require a balance between the amount of energy generated and consumed by a grid at any instant of time, one or more storage devices enable the shifting of electrical energy consumption and energy generation from one period of time to another period of time. As a consequence, the energy generated by one or more renewable resources 106, which exceeds the amount of energy required by a given load at a certain time to satisfy energy demand, in one embodiment, is stored in the energy storage resources 110. Renewable energy resources include wind turbines, solar panels including photovoltaic (PV) cells, biomass plants, hydroelectric power plants, geothermal power installations, tidal power installations, and wave power installations. In addition low cost energy which is provided by the electrical grid at a low cost during periods of low demand by the load 104 is also being stored. The stored energy is then being provided on demand when energy is required or when other forms of energy are more expensive. Dispatchable energy resources also include hydro-power, coal power, diesel generators, electrical grid connection, and gas power.

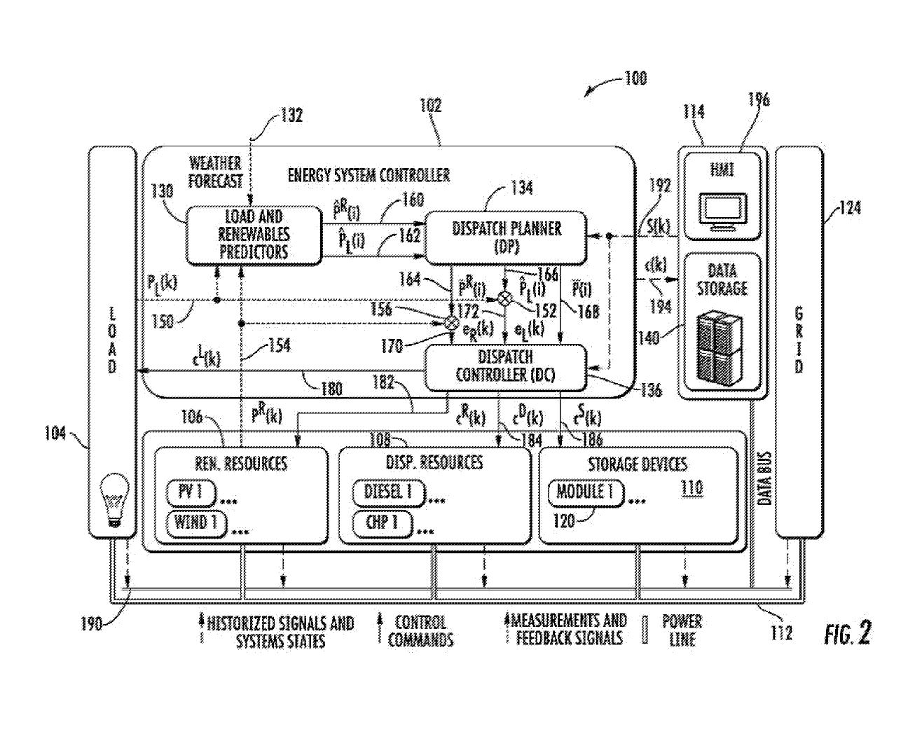

As illustrated in FIG. 2, the control system architecture 100 maximizes the benefits of an energy system with integrated stored energy resources 110, here labeled as energy storage devices 110. One or more energy storage modules 120 are operatively connected to the power line 112 which couples the electrical load 104 to an energy grid 124. The module 120 represents different or similar types of energy storage devices. In addition, the renewable energy resources 106 and the dispatchable energy resources 108 are also coupled to the power line 112. To provide for the distribution of energy from the grid 124 and the resources 106, 108, and 110, energy system controller 102 includes three components or devices that individually and/or collectively solve the tasks of power prediction, power dispatch planning, and execution of power dispatch. A load and renewable predictors module 130 provides for a prediction of the power which is generated by the renewable resources 106 which in different embodiments is dependent upon a weather forecast received at an input 132 to the module 130. A dispatch planner module 134 provides for the planning of the generation and the release or discharge of energy to the load 104. A dispatch controller 136 dispatches or directs the flow of energy provided by the renewable resources 106, the dispatchable resources 108, and the energy stored in the storage devices 110 to the power line 112. Each of the load and renewable predictors module 130 and dispatch planner module 134 are embodied in one embodiment as modules including software resident in the controller 102 or which is one embodiment configured as individual device controllers. In addition, the dispatch controller 136 in one embodiment is embodied as a module including software or as a device controller. While the modules 130, 134 and controller 136 in one embodiment are located at a single predetermined location, each of the modules 130. 134 and controller 136 in other embodiments are remotely located apart from each other if desired.

When the load and renewable predictors module 130, the dispatch planner module 134, and the dispatch controller 136 are integrated into the energy system controller 102, the modules 130, 134, and controller 136 in one embodiment direct the flow of energy and the amount of power available for the load 104 for/from the energy storage devices 110 and from the dispatchable resources 108, and the renewable resources 106 to maximize benefit of the user, which includes a cost benefit and an energy delivery benefit including the amount of electrical power and a time of its delivery.

FIG. 2 illustrates the power line 112 which provides the electrical power connections to the renewable resources 106, the dispatchable resources 108, the energy storage devices 110, and to the electrical grid 124. The energy system controller 102 receives power measurements from the load, a status of renewable and dispatchable resources and storage devices, and receives historized operation and performance data from a data storage unit 140 coupled to the controller 102. In addition, the energy system controller 102 generates power control commands for the renewable resources 106, the dispatchable resources 108, and the storage devices 110.

The controller 102 includes a plurality of inputs to receive measurement and/or status signals. As described above, the input 132 provides weather information to the predictor module 130. The weather information is obtained from any number of providers including commercial weather prediction vendors and the NOAA National Weather Service. An input 150 to the module 130 provides a signal indicative of the present or current power requirement or status of the load 104, which is also provided to a comparator 152 to be described later. An input 154 to the predictor module 130 is received from the renewable resources 106 and provides status information of the amount of power currently being produced by the renewable resources 106. The status information provided by the input 154 is also provided to a comparator 156 to be described later.

Control commands are generated internally by the controller 102. The predictor module 130, for instance, generates signals over first and second predictor module outputs 160 and 162 which are received as inputs by the planner module 134. Similarly, in response to the signals received over the first and second predictor module 130 outputs 160, 162, the planner module 134 generates signals through planner module 134 outputs 164, 166, and 168. The signal at the output 164 is applied to the comparator 156 and combined with the signal at the output 154 generated by the renewable resource 106. The signal at the output 166 is applied to the comparator 152 and combined with the signal generated by the load 104 over the input 150. An output 170 of the comparator 156 is applied as an input to the dispatch controller 136. An output 172 of the comparator 152 is applied as an input to the dispatch controller 136. The dispatch controller 136 includes an output 180 coupled to the load 104, an output 182 coupled to the renewable resources 106, an output 184 coupled to the dispatchable resources 108, and an output 186 coupled to the storage devices 110.

In addition to the feedback and control commands described above, additional control information is transmitted over a data bus 190 coupled to the load 104, the renewable resources 106, the dispatchable resources 108, the storage devices 110, the data storage unit 140, the HMI 196, and the grid 124. The data bus 190, which includes other types of communication channels, transmits data that is used to communicate command signals and variables required for operation of the system 100. The data storage unit 140 stores data and transmits data upon demand from the controller 102. An output 192 from unit 196 is coupled to the controller 102 and an input 194 to the unit 196 is coupled to the controller 102 to receive command signals. A system operator or user accesses and/or manipulates data stored in the data storage unit 140 or data received from the controller 102 over the output 194. A user interface 196 (HMI) enables a user to access information about the state of the system 100, which in one embodiment is stored in the data storage 140 or received over the output 194.

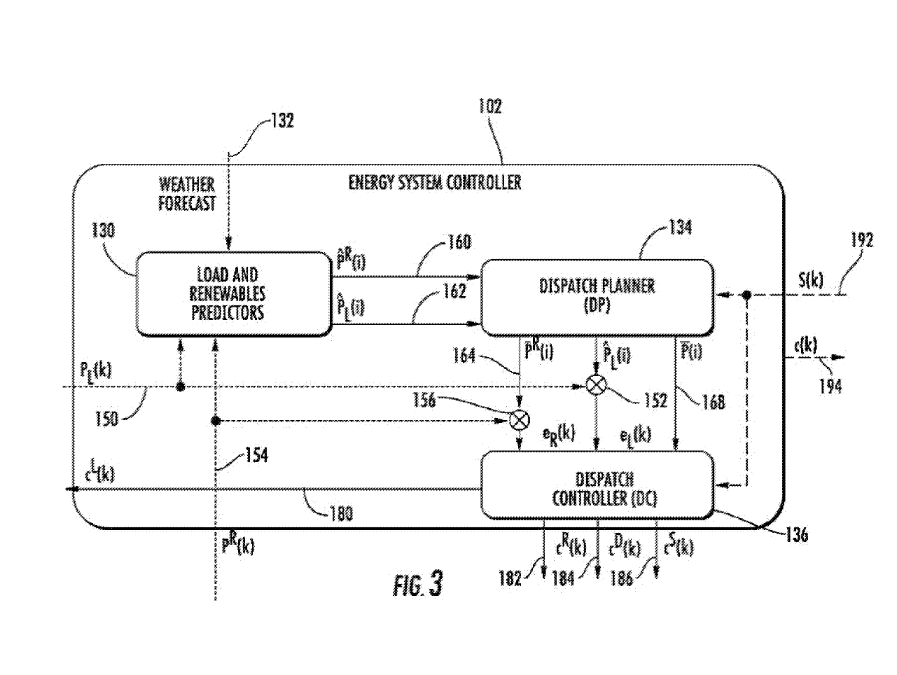

FIG. 3 illustrates a detailed view of the energy system controller 102 and the configuration and types of signals being transmitted internally between the modules 130, 134, and controller 136 and externally to and from the load 104, the resources 106, 108, and 110, and to and from the HMI 196 and data storage unit 140. The load and renewables predictors module 130 generates a prediction of the requirements of the load, \hat{P}_{L}(i), over the output 162 on a predetermined time horizon, T_{H}, and a prediction of the power to be generated or provided by the renewable resources \hat{P}^{R}(i) which is transmitted over the output 160 using the same time horizon as used for the load signal at 162. These predictions are transmitted to the dispatch planner module 134 which processes the information and responsively generates a plurality of signals to control the operation of the energy system 100 on the time horizon T_{H}.

The dispatch planner 134 generates baseline power control commands (a vector of reference signals) P̅(i) for the dispatchable resources 108 on the output 168 for transmission to the dispatch controller 136. The dispatch planner module 134 also generates baseline power control commands (a vector of reference signals) for the renewable resources P̅^{R}(i) over the output 164 which along with the load prediction \hat{P}_{L}(i), transmitted on the output 166, are compared respectively with the corresponding measurements of the power provided by the renewable resources, P^{R}(k), at comparator 156, and the load P_{L}(k) at comparator 152, to generate error signals e_{R}(k) and e_{L}(k) respectively. The error signals and the reference signal for the dispatchable resources are then provided to the dispatch controller 136 that computes control commands for transmission to the renewable resources 106 (c^{R}(k)), dispatchable resources 108 (c^{D}(k)), storage devices 110, (c^{S}(k)), and the load 104, (c^{L}(k)). These control commands are provided to individual devices and implemented by the local controllers or a controller in communication with the device. The associated controller controls at least one switch at each of the resources 106, 108, and storage devices 110 to control the release of energy to the power line 112. The error signals indicate a difference between a predicted or planned power values and actual values of the load or power generation of the renewable resources, for instance.

In order to maximize the benefits provided by energy storage devices 110, operation of the energy storage devices 110 is planned on a sufficiently long time horizon, T_{H}, in the future so that the storage devices 110 in one embodiment is charged when energy in the system 100 is most readily available and/or least expensive. In different embodiments, the time horizon includes one or more hours, one or more days, or one or more weeks or other long time horizons. The stored energy is then provided on demand to the load 104 when the energy is most needed or when a predetermined level of savings is achieved if the load is being controlled to reduce load requirements.

The dispatch planner module 134 in one embodiment performs an optimized planning of power profiles for the energy storage devices and other energy resources in the system by solving a numerical optimization problem using an optimization program or algorithm resident in firmware or software of the module 130 including memory associated with the module 130. Software resident at the user interface 114 in one embodiment is also used. In one embodiment, the long time horizon extends for one or more weeks, and the time periods used during the longer time horizon vary. For instance, during a first week, determinations of future power used and further power generation are made every hour. During a second week, determinations are made every six hours, and during a third week determinations are made very twelve hours. The determination of time periods in one embodiment is determined based on the accuracy of the weather predictions. When weather predictions are more accurate, for instance during a first week in the future, the determinations are made more often than during a second week in the future when weather predictions become less accurate.

The optimization problem is formulated with a cost function and takes into account the cost of energy, demand charges, battery efficiencies and life to depletion, maintenance and replacement costs for each component of the energy system, and other parameters that influence operating costs of the energy system 100 for a specified time horizon T_{H}. In addition to the cost function, the optimization program takes into account all the constraints imposed on different components of the system such as power limits for various resources, available amounts of energy stored in different energy storage devices, and safety constraints. These algorithms and others described herein in one embodiment are embodied as program code or program instructions in software and/or firmware resident in one of the modules, the controller, in the user interface 114, or remote devices which are coupled to the system 100 through hardwired connections, connections to the internet, or other means of communication to software or firmware either wired or wireless.

To solve the described optimization problem, the dispatch planner module 134 receives a forecasted load profile over the specified time horizon T_{H}, profiles of power that are forecasted to be generated by the renewable resources over the same time horizon, and present states of energy system components such as the amount of fuel available for dispatchable resources and the amount of energy available from various storage devices. Information about the states of components of the energy system is provided to the dispatch planner module 134 by signal S(k) over the output 192 from data storage unit 140 of FIG. 2. Information indicative of the future load profile and power profiles from renewable resources 106 is provided to the dispatch planner module 134 by the load 104 and renewables predictors module 130.

Since at any given instant of time, the future load profiles of the load 104 and the future power profiles available from the renewable resources 106 are unknown, such profiles are forecasted. The load and renewables predictors module 130 includes a number of predictor algorithms that generate forecasts of the future load requirements of load 104 and the power anticipated to be available from renewable resources 106 on the prediction time horizon T_{H}. For example in an energy system 100 having one load connection, one photovoltaic (PV) installation, (typically including large arrays of PV cells), and one wind turbine, three predictors are provided for each one of these components. Each of these predictors is represented by a mathematical model of the considered component (e.g. load, PV installation, wind turbine) and models of physical processes that influence power consumption or generation of a given component. The predictor module 130 receives measurements of the power available from or provided to the component as well as other inputs that influence the power profile and generates a prediction of the power profile. These predictions are provided to the dispatch planner module 134 in the form of signals \hat{P}_{L}(i) for the load 104 and \hat{P}_{R}(i) for the renewable resources 106.

For example, the load predictor module 130 in one embodiment is implemented with a neural network model of the load 104 that is populated or trained with historical load profiles of the energy system 100 and is capable of generating a forecast of the load 104 which occurs in the future on a timeline horizon of several hours or one or more days. In one example for instance, power requirements of a load are predicted based on power usage during a workweek as opposed to power usage during a weekend. Neural networks are known and are used in one embodiment.

The load predictor module 130 in one embodiment utilizes past measurements of the load power requirements as well as other variables such as current and future time variables, day of the week, time of the year, weather forecast on the specified time future horizon and other variables to generate the prediction \hat{P}_{L}(i). A predictor algorithm for the PV installation in one embodiment is embodied by in program code providing a deterministic model that computes solar irradiance at a given geographical location for any time of the day and year which is adjusted by a weather forecast predicting cloud cover, humidity and other atmospheric parameters for time T_{H} in the future. The solar irradiance is considered in one embodiment as a part of the weather forecast. The power provided by the PV installation is determined than from the solar irradiance utilizing the mathematical model mapping irradiance into the power output. Similarly, the wind power predictor in one embodiment utilizes a mathematical model of the installed wind turbine along with the weather forecasts about temperature, humidity, wind speed and direction for the next time horizon T_{H}. Signal P^{R}(k) provides information about the power generation by renewable resources at time instant k that is used by the predictors of the renewable power.

In one embodiment, a dispatch strategy computed by the dispatch planner module 134 relies on the prediction of load 104 and power available from the renewable resources 106. Due to prediction uncertainties and errors, modeling inaccuracies, and temporal variations in load profiles, and renewable profiles, a mismatch may occur between the predicted load and power profiles and the true load and power profiles. In addition to that mismatch, since both the predictors module 130 and dispatch planner module 134 need time to compute the predictions and the optimal dispatch strategy for the next time horizon, the predictors module 130 and dispatch planner module 134 of the energy system controller 102 operate at a sampling rate less than the speed required to compensate for an instantaneous variation of load demand and power supply.

To compensate for the potentially faster variations of load demand and power supply from the renewable resources, the control system incorporates the dispatch controller 136. The dispatch controller 136 uses optimally planned profiles generated by the dispatch planner module 134 as reference inputs, and computes the errors, e_{R}(k) and e_{L}(k), between the predicted profiles and the measurements collected at a high sampling rate, and generates final command inputs to the energy system resources. In one embodiment, the predictors module 130 and the dispatch planner module 134 operate at a sampling rate of approximately between 15 minutes and 1 hour. This sampling rate is limited by the update rate of forecasts for the load 104 and renewable resources 106 and by the amount of time required to perform the optimization.

To compensate for the errors which accumulate due to prediction inaccuracies and temporal variations, the dispatch controller 136 compares reference inputs from the dispatch planner with the measurements received from the load P_{L}(k) and renewable resources P^{R}(k), computes the corresponding errors e^{L}(k), e^{R}(k) and augments reference commands from the dispatch planner module 134 with correction signals to generate power commands c^{D}(k) to dispatchable resources 108, power commands c^{S}(k) storage devices 110, throttling commands c^{R}(k) to renewable resources 106 and, if load devices allow demand management, load regulation commands c^{L}(k) to the load 104. In one embodiment command signals generated by the dispatch controller 136 are computed by augmenting the reference signals received from the dispatch planner module 134 with corrections that constitute fractions of the combined error, e(k)=Σe_{R}(k)−Σe_{L}(k).

The throttling commands are generated in situations when the renewable resources 106 provide or are providing more power at a given sample time k than the amount of power than is capable of being absorbed by the load 104, storage devices 110 or the dispatchable resources 108. The throttling commands are transmitted to the renewable resources 106 to reduce the amount of energy being generated by the renewable resources. In the case of the PV arrays, in one embodiment the alignment of the arrays with respect to the sun are adjusted to misalign the arrays with respect to the path of sunlight, or in another embodiment the connection to the power line 112 is disconnected. In the case of wind turbines and in different embodiments, the blade angle is adjusted to limit the amount of rotation or the blades are disconnected from the gearbox or generator.

The sampling time for the dispatch controller 136 is denoted by k, while the sampling time for the predictors module 130 and the dispatch planner module 134 is denoted by i. This distinction is made to indicate that the sampling rate of the predictors module 130 and dispatch planner module 134 is slower than the faster sampling rate of the dispatch controller 136. In one embodiment, the sampling rate of the dispatch controller 136 is on the order of fractions of a minute to several seconds, milliseconds or other short time intervals. This sampling rate is limited by the sampling rates of the measurement devices acquiring instantaneous power of the load and the Renewable resources and the amount of time required to generate the control commands c^{R}(k), c^{D}(k), c^{S}(k), c^{L}(k).

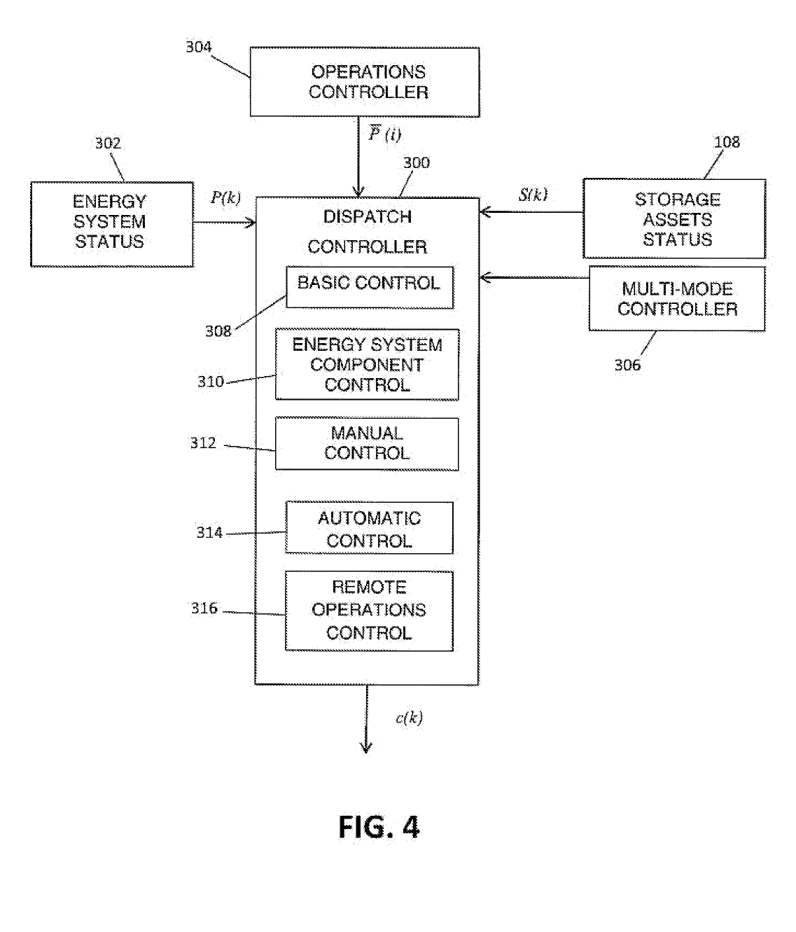

In accordance with the disclosure, the dispatch controller comprises a multi-mode dispatch controller 300, an embodiment of which is depicted in FIG. 4. As depicted in FIG. 4, along with the inputs described above containing information about the state of the energy system, reference signals from the dispatch planner 200, and feedback signals from the renewable energy sources 108, the dispatch controller 300 also receives input signals commanding operation of the dispatch controller 300 according to one or more modes of operation. In this configuration, the dispatch controller 300 represents a central block of an energy system controller that performs both basic and more advanced tasks to ensure accurate and reliable operation of an energy system.

While benefits provided by the energy system controller 102 come from forecasting and planning implemented with the predictors 202 and the dispatch planner 200 of FIG. 2, dispatch controller 300 provides a method, apparatus, and/or system configured to execute an optimized dispatch strategy. The dispatch controller 300 also serves as a back-up controller when predictors 202 or the dispatch planner 200 malfunction or fail. The dispatch planner 300 also enables operation of an energy system in a manual mode, operation of an energy system in a safe mode, and responds to commands from a remote multi-mode controller 306, the application of which for instance, would be available for use by an energy exchange trader. As such, the dispatch controller 300, in different embodiments, operates both autonomously and under command from one or more higher level controllers or one or more algorithms.

The dispatch controller 300 is configured to be operated in a number of different modes of operation, each of which is defined by a different control scheme for routing the flow of energy between the renewable energy source(s), storage, and/or the load(s). The modes of operation may be implemented by one or more controllers, dedicated algorithms, programmed instructions, and the like which are collectively embodied by the controller 300. While each of the mode controllers are illustrated as being a part of the controller 300, the controller 300 can include any one or any combination of two or more of the mode controllers. In addition, the controllers, in other embodiments, are externally located outside of the dispatch controller 300.

In a secure operating mode (mode one (1)), the dispatch controller 300 is configured to control the flow of energy according to a secure dispatching control scheme or algorithm 308. In the secure operating mode, the controller 300 does not operate according to one or more advanced power dispatch algorithms, which are provided by the dispatch planner 200 in the embodiment of FIG. 2, but instead operates in a relatively simple operating mode using a secure dispatching scheme 308. The secure dispatching scheme may comprise a basic algorithm which has been predetermined to provide a safe and secure method of routing energy within the system. As one example, a secure dispatching scheme may define the flow of energy such that a load is supplied with power available only from the grid.

The dispatch controller 300 operates in the secure operating mode, in different embodiments, in response to a secure mode command signal generated by and received from a higher level controller or system operator, such as provided by the controller 304. The secure operating mode, in another embodiment, is automatically triggered after the dispatch controller 300 detects a potentially problematic or faulty behavior of the energy system or of one or more of the components of the energy system. Different secure dispatching schemes may used provided for use in response to different types of events or faults detected in the system.

In an operations mode (mode two (2)), which may also be referred to as a normal operating mode, the dispatch controller 300 operates as a normal component of the energy system controller 102 as described above with respect to FIG. 2. In this operation mode, the dispatch controller 300 receives reference signals from the dispatch planner 200, feedback signals from the resources, and information about the states of the resources 108. The dispatch controller 300 generates dispatch commands to the renewable resources, c^{R}(k), dispatchable resources, c^{D}(k), storage devices, c^{S}(k), and the load c^{L}(k).

In a manual operation mode (mode three (3)), the dispatch planner 300 includes a manual controller or algorithm 312 which responds to commands (signals) provided by an operator or user of the system, which in one embodiment is provided by controller 306. In the manual operation mode, resources of the energy system are controlled directly by transmitting commands to the dispatch controller 300 which responds accordingly. The dispatch controller 300 analyzes the provided commands for constraints violations and human errors. The commands, if acceptable, are executed by the dispatch controller 300 through transmission of corresponding dispatch signals to the resources. Operator commands include one or more detailed sets of command power instructions for each individual resource participating in the regulation of energy flow in the system. Operator commands, in other embodiments are more general in nature, such as a command to supply a load by using a combination of resources, while distributing power according to some predetermined algorithm.

In an automatic operating mode (mode four (4)), the dispatch controller 300 includes an automatic controller or algorithm 314 which operates the energy system resources according to a specified predetermined algorithm. In this automatic operating mode, the dispatch controller 300 utilizes an algorithm using logic based rules such as a cycle charging algorithm or a load following algorithm to operate the resources.

In a remote operating mode (mode five (5)), the dispatch controller 300 includes a remote operations controller or algorithm 316 which operates similarly to the operation of the dispatch controller 204 when it follows reference commands provided by the dispatch planner 200 in FIG. 2. In this mode, however, the signals are no longer generated by the dispatch planner 200, but are instead provided by the remote controller 306 using algorithms which are not located in the dispatch planner 200, but which are located in the controller 306 or which are accessible by the controller 306. This remote operating mode is implemented, for instance, when a selected energy system participates in energy trading subject to control by an energy/power broker or an energy system whose transfer and delivery of power is orchestrated by a centralized algorithm. Generally, the energy system participating in energy trading subject to control by an energy/power broker is a smaller system, when compared to an energy system which is operates according to a centralized algorithm.

Of the five operating modes described herein, implementations for mode two and mode five share some common characteristics. In these two operating modes, the dispatch controller 300 is configured in a similar fashion to receive external reference commands, collect feedback signals and other status information, and to generate dispatch commands to resources. Operating mode one described herein, in one embodiment, is specifically adapted to a given energy system where employed and is defined to include preferred operating requirements particular to the specific system. The manual operating mode provides for direct control of the energy resources subject to secure operating constraints. Operating mode four involves automatic implementation of specified logic or algorithm routines.

While the modes are discussed as being distinct, an energy system can include one or more energy system controllers each of which includes one mode or more than one mode in any combination. For instance, in one embodiment, the energy system can include an energy system controller configured to operate in mode 1, the secure mode, and in mode 2, the operation mode. In another embodiment, the energy system can include an energy system controller configured to operate in mode 2, the operation mode, and in mode 5, the remote operating mode. In addition, while five modes are discussed, the present invention is not limited to five modes.

When the dispatch control module is operating in an operating mode in which command signals are generated based on reference power profiles (e.g., normal operating mode and remote operating mode, the dispatch controller 300 is configured to compensate for errors representing the difference between the predicted power outputs of energy system components, provided by the dispatch planner 200, and the real power outputs of these components in the energy system. Possible components of the energy system are loads, grid supply, photovoltaic supply, diesel supply, wind power, and energy storage. At each dispatch controller sampling step k, dispatch controller 300 solves an optimization problem and minimizes a cost of compensation for the errors which exist between the forecasted value of power requirements and the true measured values of the load requirements and actual renewable energy generation.

In this embodiment, the notations and assumptions about input variables for the dispatch controller 300 include the variables for a single operating step of the dispatch planner 200. The single operating step is denoted with time variable “i” and indicates that the interval of time between the reference inputs updates from the dispatch planner 200. These updates include two or more samples of the dispatch controller 300 defined with a time variable “k”. In one embodiment, the reference commands, provided by the dispatch planner 200, are updated once an hour, while the dispatch controller 300 operates with a sampling rate of once a minute. For simplicity of notation, the time stamps in the formulas detailed below are eliminated, keeping in mind that the corresponding variables are updated with their respective sampling rates.

In this embodiment, the dispatch planner 300 provides a vector that contains command powers for all dispatchable resources such as energy storage, grid, and generation components of the connected energy system for the next time interval: P̅=[P̅₁ P̅₂ . . . P̅ₙ], where n is the number of components in an energy system that participates in the regulation of power. A vector of predicted and possibly throttled or reduced powers from renewable resources such as PV and wind are defined as P̅^{R}=[P̅₁^{R} P̅₂^{R} . . . P̅ₖ^{R}]. A vector of predicted loads P̅^{L}=[P̅₁^{L} P̅₂^{L} . . . P̅ₘ^{L}] is defined and guarantees that the power balance between the predicted variables is satisfied such that Σᵢ₌₁ⁿP̅ᵢ+Σⱼ₌₁^{k}P̅ⱼ^{R}=Σᵢ₌₁^{M}P̅₁^{L}. If the loads allow demand management, then the vector P̅^{L} contains the regulated load values instead of forecasts. These variables are updated with the time variable i.

The dispatch controller 200 has access to the real-time measurements of the energy available, and therefore the power capable of being generated, from each of the renewable resources Pⱼ^{R}, j=1, . . . , k and real time measurements of load power requirements Pᵢ^{L}, l=1, . . . , m. These measurements are updated with the time variable k.

The dispatch planner includes a cost function for each of the energy system resources, cᵢ(Pᵢ), each of which is a function of power Pᵢ from or to the i^{th} resource during the next time interval. In this embodiment, the dispatch controller 300 receives information about operating constraints for each of the arguments of the cost functions, Pᵢε[Pᵢ^{l}, Pᵢ^{M}] where Pᵢ^{l} and Pᵢ^{M} are correspondingly the lower and upper power bounds. The total cost of power from all energy system resources is defined as c(P)=Σᵢ₌₁ⁿcᵢ(Pᵢ), where P is a vector of resource powers. Based on this information, the dispatch controller 300 redistributes the power between the components of the energy system to guarantee that the balance between the real time power from the resources, Pᵢ, and renewables to the load is satisfied, Σᵢ₌₁ⁿPᵢ=Σⱼ₌₁ⁿPⱼ^{R}=Σₗ₌₁^{m}P₁^{L} with a minimum cost, c(P).

The dispatch controller 300 generates controller inputs to the dispatchable resources, cᵢ^{D}, that take into account the commands from the dispatch planner 200. The controller inputs adjust the outputs of the dispatchable resources to compensate for the prediction errors. In order to determine the corrections, the dispatch controller 300 computes the renewable energy source errors, eⱼ^{R}=P̅ⱼ^{R}−Pⱼ^{R}, and the loads errors, e₁^{L}=P̅₁^{L}−P₁^{L}. Then the dispatch controller 300 finds the total power error in the energy system to be distributed between the resources, e=Σⱼ₌₁^{k}eⱼ^{R}−Σₗ₌₁^{m}e₁^{L}. Control inputs to each of the dispatchable resources are then defined as, cᵢ^{D}=P̅ᵢ+pᵢe, where pᵢ is the portion of the total error to be compensated by the i^{th} resource and the first component of the control signal, P̅ᵢ, corresponds to a feed-forward term provided by the dispatch planner 200, while the second component pᵢe corresponds to a feedback term compensating for the prediction error.

To find pᵢ for each of the energy system resources, at each sampling step i, the dispatch controller 300 solves an optimization problem of minimizing the cost function c=Σᵢ₌₁ⁿcᵢ(P̅ᵢ+pᵢe) subject to linear constraints on the arguments: for each cᵢ(P̅ᵢ+pᵢe), (P̅ᵢ+pᵢe)ε[Pᵢ^{l},Pᵢ^{u}]—(constraint 1),

$${\sum }_{i = 1}^{n} {p}_{i} = 1 ,$$

and for each pᵢ, i=1, . . . , n, pᵢε[0,1]—(constraint 2). The problem formulation is then min(c(p)), p=[p₁, p₂, . . . , pₙ] subject to (constraint 1) and (constraint 2). Each pᵢ defines what portion of the total prediction error has to be compensated by the i^{th} resource. If any of the resources are to be excluded from the optimization, then the corresponding pᵢ can be set to be equal to zero. When the optimization problem has a solution that satisfies the constraints, the sum of correction control inputs is equal to the prediction error, μᵢ₌₁ⁿpᵢe=e and the total power delivered to the load is equal to:

$$\begin{matrix}{\sum }_{i = 1}^{n} ( {\overline{P}}_{i} + {p}_{i} e ) + {\sum }_{j = 1}^{k} {P}_{j}^{R} = {\sum }_{i = 1}^{n} {\overline{P}}_{i} + e + {\sum }_{j = 1}^{k} {P}_{j}^{R} = \\ = {\sum }_{i = 1}^{n} {\overline{P}}_{i} + ( {\sum }_{j = 1}^{k} {e}_{j}^{R} - {\sum }_{l = 1}^{m} {e}_{l}^{L} ) + {\sum }_{j = 1}^{k} {P}_{j}^{R} \\ = {\sum }_{i = 1}^{n} {\overline{P}}_{i} + {\sum }_{j = 1}^{k} {\overline{P}}_{j}^{R} - {\sum }_{j = 1}^{k} {P}_{j}^{R} - \\ {\sum }_{l = 1}^{m} {e}_{l}^{L} + {\sum }_{j = 1}^{k} {P}_{j}^{R} = \\ = {\sum }_{l = 1}^{m} {\overline{P}}_{l}^{L} - {\sum }_{l = 1}^{m} {e}_{l}^{L} = {\sum }_{l = 1}^{m} {P}_{l}^{L} ,\end{matrix}$$

hence the controller achieves its goal of compensation for the prediction errors.

If the amount of power available from all renewable resources at any instant of time, Σⱼ₌₁^{k}Pⱼ^{R}, exceeds power that can be accepted by the load and dispatchable resources, such that Σⱼ₌₁^{k}Pⱼ^{R}>Σₗ₌₁^{m}Pₗ^{L}−Σᵢ₌₁ⁿPᵢ^{l}, then the excess power capable of being delivered by the renewable energy source is throttled or reduced. To manage that case, the dispatch controller 300 of FIG. 3 checks for this condition prior to performing the optimization described above and computes throttling commands, cⱼ^{R}, if necessary. Throttling commands reduce the amount of power delivered by the renewables and ensure that the optimization problem has a feasible solution.

In the situation when the loads allow demand management, some of the elements in vector P̅^{L}=[P̅₁^{L} P̅₂^{L} . . . P̅ₘ^{L}] contain the commanded load values instead of the forecasted ones. In this situation, load commands from the dispatch controller 204, cₗ^{L}(k), l=1, . . . m, contain these demand management commands.

In another embodiment, the total power error e=Σⱼ₌₁^{k}eⱼ^{R}−Σₗ₌₁^{m}eₗ^{L}, defined above, is divided between the energy system resources based on a set of logic-based rules instead of a result of an optimization problem solution. The logic rules are configured according to the particular architecture of the considered energy system and according to the tasks to be solved by the energy system components. In one embodiment, the set of rules states that the power error is compensated completely by a single one of the resources, the grid for example, up to a certain power limit. Once the power limit is exceeded, the rest of the error is compensated for by another resource, for example battery storage. In one embodiment, the selection of the battery storage delivering power to the grid is sequential and occurs in a predetermined order based on an order in which resources are located in a queue.

The dispatch controller 300 of FIG. 4 therefore provides a critical function in an energy management system, as the controller 300 implements execution tasks and provides various operating modes, including basic operating modes and advanced operating modes, including the secure operating mode and the manual mode. As a result, the dispatch controller 300, in certain embodiments, is implemented in the proposed energy control systems in a robust fashion. While other components, such as the block of predictors 202 and the dispatch planner 200 are implemented on a server or a computer running under one of the known operating systems, and not necessarily working in real time, the dispatch controller 300, in some embodiments, is implemented in a hardware device operating in real time. Such an implementation includes, but is not limited to, a programmable logic controller (PLC), a microprocessor or an engine control unit (ECU). In addition, in one or more of these embodiments, the dispatch controller 300 is directly connected to sensors measuring power inputs and outputs of the resources. Direct connections are also made for the receipt of other signal information provided by other real-time controllers. In an energy system having stringent specifications for security and/or reliability, the dispatch controller 300, in one embodiment, is implemented in a redundant architecture with two or more hardware control units working simultaneously and exchanging information about faults and errors. While one of the two control units performs control tasks described herein, the other control unit serves as a back-up unit if a failure of the first one occurs.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following embodiments. The following embodiments are provided as examples and are not intended to be limiting.

What is claimed is:

1. An energy system controller for an energy control system, the energy system controller being configured to be coupled to at least one renewable energy source and to at least one electrical load, the energy system controller comprising:
a predictor module configured to generate predictions of an amount of power to be generated by the renewable energy source during a time period and an amount of power required by the electrical load during the time period;
a dispatch planner module configured to generate reference power profiles based in part on the predictions generated by the predictor module; and
a dispatch control module configured to generate command signals that are configured to control a flow of energy from the renewable energy resource to the electrical load during the time period,
wherein the dispatch control module is configured to operate in a plurality of modes of operation, each of the modes of operation defining a different control scheme that is used by the dispatch controller to route energy in the energy control system, the plurality of modes of operation including at least a normal operating mode, a secure operating mode, and a manual operating mode,
wherein, in the normal operating mode, the dispatch control module is configured to generate the command signals based in part on the reference power profiles generated by the dispatch planner module,
wherein, in the secure operating mode, the dispatch control module is configured to generate the command signals using a secure dispatching scheme without reference to the reference power profiles generated by the dispatch planner module, the secure operating mode being activated in response to a secure mode command signal, and
wherein, in the manual operating mode, the dispatch control module is configured to generate the command signals based on input received via a user interface.

2. The energy system controller of claim 1, wherein the plurality of operating modes further comprises an automatic operating mode and a remote operating mode,
wherein, in the automatic operating mode, the dispatch control module is configured to generate the command signals based on a predetermined algorithm, and
wherein, in the remote operating mode, the dispatch control module is configured to generate the command signals based on remote power profiles received from a remote control system.

3. The energy system controller of claim 1, wherein the dispatch control module is configured to receive measurements of an power measurements of actual power generated by the renewable energy source and actual power required by the electrical load, and
wherein the dispatch control module is configured to generate the command signals in at least the normal operating mode as a function of the power measurements and the reference power profiles.

4. The energy system controller of claim 3, wherein the reference power profiles generated by the dispatch planner module comprise baseline command signals configured to control a flow of energy from the renewable energy resource to the electrical load.

5. The energy system controller of claim 4, wherein the dispatch control module is configured to determine errors between the power measurements and the reference power profiles and to adjust the baseline command signals based on the determined errors to generate the command signals.

6. The energy system controller of claim 5, wherein the dispatch control module is configured to generate the command signals based on an optimization algorithm which defines how to distribute the determined errors between the renewable energy source and the electrical load.

7. The energy system controller of claim 5, wherein the dispatch control module is configured to generate the command signals based on logic rules which defines the energy system resources that are to be used to compensate for the errors.

8. The energy system controller of claim 7, wherein the logic rules define an order in which energy resources are to be activated to release power.

9. A method of controlling an energy system, the method comprising:
using a prediction module to generate a prediction of an amount of power to be generated by a renewable energy source during a time period and an amount of power required by an electrical load during the time period;
generating a reference power profile based in part on the prediction generated by the predictor module using a dispatch planner module;
using a dispatch control module to generate command signals that are configured to control a flow of energy from the renewable energy resource to the electrical load during the time period, the command signals being dependent in part on which one of a plurality of different operating modes that the dispatch control module is operating in, the plurality of modes of operation including at least a normal operating mode, a secure operating mode, and a manual operating mode,
wherein, in the normal operating mode, the dispatch control module is configured to generate the command signals based in part on the reference power profiles generated by the dispatch planner module,
wherein, in the secure operating mode, the dispatch control module is configured to generate the command signals using a secure dispatching scheme without reference to the reference power profiles generated by the dispatch planner module, the secure operating mode being activated in response to a secure mode command signal, and
wherein, in the manual operating mode, the dispatch control module is configured to generate the command signals based on input received via a user interface.

10. The method of claim 9, wherein the plurality of operating modes further comprises an automatic operating mode and a remote operating mode,
wherein, in the automatic operating mode, the dispatch control module is configured to generate the command signals based on a predetermined algorithm, and
wherein, in the remote operating mode, the dispatch control module is configured to generate the command signals based on remote power profiles received from a remote control system.

11. The method of claim 9, wherein the dispatch control module is configured to receive measurements of an power measurements of actual power generated by the renewable energy source and actual power required by the electrical load, and
wherein the dispatch control module is configured to generate the command signals in at least the normal operating mode as a function of the power measurements and the reference power profiles.

12. The method of claim 11, wherein the reference power profiles generated by the dispatch planner module comprise baseline command signals configured to control a flow of energy from the renewable energy resource to the electrical load.

13. The method of claim 12, wherein the dispatch control module is configured to determine errors between the power measurements and the reference power profiles and to adjust the baseline command signals based on the determined errors to generate the command signals.

14. The method of claim 13, wherein the dispatch control module is configured to generate the command signals based on an optimization algorithm which defines how to distribute the determined errors between the renewable energy source and the electrical load.

15. The method of claim 13, wherein the dispatch control module is configured to generate the command signals based on logic rules which defines the energy system resources that are to be used to compensate for the errors.

16. The method of claim 15, wherein the logic rules define an order in which energy resources are to be activated to release power.
